(19) United States
(12) Patent Application Publication
(10) Pub. No.: US 2026/0059327 A1
(43) Pub. Date: Feb. 26, 2026

(54) COORDINATED SPATIAL REUSE WITH RESTRICTED MEDIUM SHARING

(71) Applicant: QUALCOMM Incorporated, San Diego, CA (US)

(72) Inventors: Sherief HELWA, San Diego, CA (US); George CHERIAN, San Diego, CA (US); Abhishek Pramod PATIL, San Diego, CA (US); Gaurang NAIK, San Diego, CA (US); Giovanni CHISCI, San Diego, CA (US); Sanket Sanjay KALAMKAR, San Diego, CA (US); Alfred ASTERJADHI, San Diego, CA (US); Sai Yiu Duncan HO, San Diego, CA (US)

(21) Appl. No.: 18/810,013

(22) Filed: Aug. 20, 2024

(51) Int. Cl. H04W 16/10; H04W 16/14; H04W 24/10; H04W 72/044

(52) U.S. Cl. CPC H04W 16/10; H04W 16/14; H04W 24/10; H04W 72/046

(57) ABSTRACT

This disclosure provides methods, components, devices and systems for coordinated spatial reuse (CSR) with restricted medium sharing. Some aspects more specifically relate to a CSR framework. In some examples, access points (APs) may each create a first list of APs that either indicates compatible APs for CSR or incompatible APs for CSR, and may broadcast the first list of APs to the APs. Each AP may generate one or more final lists based on the first lists, where each final list may indicate a subset of the APs that are each compatible with each other for CSR. A sharing AP may transmit an SP announcement that indicates a final list of APs and one or more reuse SPs, and APs included in the final list of APs may communicate with respective STAs during the reuse SPs based on receiving the SP announcement.

### TECHNICAL FIELD

This disclosure relates generally to wireless communication and, more specifically, to coordinated spatial reuse (CSR) with restricted medium sharing.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One inventive concept of this disclosure includes a method for wireless communication by a first access point (AP). The method may include receiving a set of multiple first lists of APs from a set of multiple APs, where each first list of APs of the set of multiple first lists of APs indicates one or more APs that are compatible with a list sending AP of the set of multiple APs for CSR, or indicates one or more APs that are incompatible with the list sending AP for CSR, transmitting a SP announcement that indicates a SP and a second list of APs that is based on the set of multiple first lists of APs, where the second list of APs indicates one or more second APs that are compatible with the first AP for CSR within the SP, where the first AP is an owner of the SP, and communicating, within the SP, a first message with a wireless station (STA) associated with the first AP concurrently with communication of a second message associated with a second AP of the one or more second APs.

Another inventive concept of this disclosure includes a first AP for wireless communication. The first AP may include a processing system that includes processor circuitry and memory circuitry that stores code. The processing system may be configured to cause the first AP to receive a set of multiple first lists of APs from a set of multiple APs, where each first list of APs of the set of multiple first lists of APs indicates one or more APs that are compatible with a list sending AP of the set of multiple APs for CSR, or indicates one or more APs that are incompatible with the list sending AP for CSR, transmit a SP announcement that indicates a SP and a second list of APs that is based on the set of multiple first lists of APs, where the second list of APs indicates one or more second APs that are compatible with the first AP for CSR within the SP, where the first AP is an owner of the SP, and communicate, within the SP, a first message with a wireless STA associated with the first AP concurrently with communication of a second message associated with a second AP of the one or more second APs.

Another inventive concept of this disclosure includes another first AP for wireless communication is described. The first AP may include means for receiving a set of multiple first lists of APs from a set of multiple APs, where each first list of APs of the set of multiple first lists of APs indicates one or more APs that are compatible with a list sending AP of the set of multiple APs for CSR, or indicates one or more APs that are incompatible with the list sending AP for CSR, means for transmitting a SP announcement that indicates a SP and a second list of APs that is based on the set of multiple first lists of APs, where the second list of APs indicates one or more second APs that are compatible with the first AP for CSR within the SP, where the first AP is an owner of the SP, and means for communicating, within the SP, a first message with a wireless STA associated with the first AP concurrently with communication of a second message associated with a second AP of the one or more second APs.

Another inventive concept of this disclosure includes a non-transitory computer-readable medium storing code for wireless communication is described. The code may include instructions executable by one or more processors to receive a set of multiple first lists of APs from a set of multiple APs, where each first list of APs of the set of multiple first lists of APs indicates one or more APs that are compatible with a list sending AP of the set of multiple APs for CSR, or indicates one or more APs that are incompatible with the list sending AP for CSR, transmit a SP announcement that indicates a SP and a second list of APs that is based on the set of multiple first lists of APs, where the second list of APs indicates one or more second APs that are compatible with the first AP for CSR within the SP, where the first AP is an owner of the SP, and communicate, within the SP, a first message with a wireless STA associated with the first AP concurrently with communication of a second message associated with a second AP of the one or more second APs.

In some examples of the method, first access points (APs), and non-transitory computer-readable medium described herein, the first message may be communicated based on a channel occupancy time period associated with the second message being ignored.

Some examples of the method, first access points (APs), and non-transitory computer-readable medium described herein may further include operations, features, means, or instructions for receiving an updated first list of APs from at least one AP of the set of multiple APs and transmitting a second SP announcement that indicates a second SP and an updated second list of APs based on the updated first list of APs.

Some examples of the method, first access points (APs), and non-transitory computer-readable medium described herein may further include operations, features, means, or instructions for transmitting an indication of one or more medium sharing rules, where communication of the first message concurrently with the communication of the second message within the SP may be based on the one or more medium sharing rules.

Another inventive concept of this disclosure includes a method for wireless communication by a second AP is described. The method may include transmitting a first list of APs, where the first list of APs indicates one or more APs that are compatible with the second AP for CSR or indicates one or more APs that are incompatible with the second AP for CSR, receiving, from a first AP, a SP announcement that indicates a SP and a second list of APs that is based on the first list of APs, where the second list of APs indicates one or more second APs that are compatible with the first AP for CSR within the SP, where the one or more second APs include the second AP, and where the first AP is an owner of the SP, and communicating, within the SP, a first message with a wireless STA associated with the second AP concurrently with communication of a second message associated with another second AP of the one or more second APs or the first AP.

Another inventive concept of this disclosure includes a second AP for wireless communication is described. The second AP may include a processing system that includes processor circuitry and memory circuitry that stores code. The processing system may be configured to cause the second AP to transmit a first list of APs, where the first list of APs indicates one or more APs that are compatible with the second AP for CSR or indicates one or more APs that are incompatible with the second AP for CSR, receive, from a first AP, a SP announcement that indicates a SP and a second list of APs that is based on the first list of APs, where the second list of APs indicates one or more second APs that are compatible with the first AP for CSR within the SP, where the one or more second APs include the second AP, and where the first AP is an owner of the SP, and communicate, within the SP, a first message with a wireless STA associated with the second AP concurrently with communication of a second message associated with another second AP of the one or more second APs or the first AP.

Another inventive concept of this disclosure includes another second AP for wireless communication is described. The second AP may include means for transmitting a first list of APs, where the first list of APs indicates one or more APs that are compatible with the second AP for CSR or indicates one or more APs that are incompatible with the second AP for CSR, means for receiving, from a first AP, a SP announcement that indicates a SP and a second list of APs that is based on the first list of APs, where the second list of APs indicates one or more second APs that are compatible with the first AP for CSR within the SP, where the one or more second APs include the second AP, and where the first AP is an owner of the SP, and means for communicating, within the SP, a first message with a wireless STA associated with the second AP concurrently with communication of a second message associated with another second AP of the one or more second APs or the first AP.

Another inventive concept of this disclosure includes a non-transitory computer-readable medium storing code for wireless communication is described. The code may include instructions executable by one or more processors to transmit a first list of APs, where the first list of APs indicates one or more APs that are compatible with the second AP for CSR or indicates one or more APs that are incompatible with the second AP for CSR, receive, from a first AP, a SP announcement that indicates a SP and a second list of APs that is based on the first list of APs, where the second list of APs indicates one or more second APs that are compatible with the first AP for CSR within the SP, where the one or more second APs include the second AP, and where the first AP is an owner of the SP, and communicate, within the SP, a first message with a wireless STA associated with the second AP concurrently with communication of a second message associated with another second AP of the one or more second APs or the first AP.

In some examples of the method, second access points (APs), and non-transitory computer-readable medium described herein, the first message may be communicated based on a channel occupancy time period associated with the second message being ignored.

Some examples of the method, second access points (APs), and non-transitory computer-readable medium described herein may further include operations, features, means, or instructions for transmitting an updated first list of APs to at least one AP of the set of multiple APs or the first AP and receiving a second SP announcement that indicates a second SP and an updated second list of APs based on the updated first list of APs.

In some examples of the method, second access points (APs), and non-transitory computer-readable medium described herein, at least one second AP indicated by the second list of APs may be incompatible with at least one third AP indicated by the third list of APs for CSR.

Details of one or more implementations of the subject matter described in this disclosure are set forth in the accompanying drawings and the description below.

Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a pictorial diagram of another example wireless communication network.

FIG. 4 shows an example of a process flow that supports coordinated spatial reuse (CSR) with restricted medium sharing.

FIG. 5 shows an example of a wireless communications system that supports CSR with restricted medium sharing, where one or more APs may communicate incompatible lists.

FIG. 6 shows an example of a resource diagram that supports CSR with restricted medium sharing, where some wireless stations (STAs) may communicate with an AP during reuse periods and other STAs may not.

FIG. 7 shows an example of a resource diagram that supports CSR with restricted medium sharing, where APs may share a reuse period based on AP compatibility lists.

FIG. 8 shows a block diagram of an example wireless communication device that supports CSR with restricted medium sharing.

FIG. 9 shows a flowchart illustrating an example process performable by or at a first AP that supports CSR with restricted medium sharing.

FIG. 10 shows a flowchart illustrating an example process performable by or at a second AP that supports CSR with restricted medium sharing.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a first access point (AP) may communicate with one or more wireless stations (STAs) over a medium (communication resources, frequency resources), and may perform restricted medium sharing with a second AP (of an overlapping basic service set (OBSS)) when a received power associated with the second AP is below a threshold power (such as an energy detection (ED) threshold of clear channel assessment (CCA) rules). Restricted medium sharing may include implementing coordinated spatial reuse (CSR) techniques, which may allow the first AP and the second AP (which may be geographically relatively close to one another) to communicate with respective wireless stations (STAs) simultaneously or concurrently. For example, the first AP (such as a sharing AP) may determine one or more reuse service periods (SPs) (time windows) to share the medium with the second AP (such as one or more shared APs). The first AP also may determine one or more orthogonal SPs that may not be for sharing the medium with the second AP. In some examples, the first AP may broadcast an indication of the one or more reuse SPs to one or more shared APs that include the second AP. The second AP may not utilize the one or more reuse SPs if the second AP determines that a received signal power (such as from any AP during the one or more first SPs) is greater than the threshold power. However, the threshold power may still allow relatively high levels of interference (such as created by the one or more shared APs) within the one or more reuse SPs, which may degrade communication quality and decrease communication throughput during the one or more reuse SPs.

Various aspects relate generally to CSR frameworks for restricted medium sharing. In some examples, one or more APs may determine and indicate one or more APs of a plurality of APs that are to share the medium during one or more reuse SPs. For example, the first AP (and each AP of the plurality of APs) may create a first list of APs that either indicates one or more APs compatible with the first AP for CSR (reuse SPs, a compatible list) or one or more APs incompatible with the first AP for CSR (non-reuse SPs, an incompatible list), and may transmit (such as broadcast) the first list of APs to multiple other APs. The first AP (and each AP of the multiple APs) may receive similar first lists of APs associated with each other AP and may generate one or more final lists of APs based on the first lists of APs. Each final list of APs associated with the first AP may indicate a subset of APs of the multiple APs that are each compatible with each other (and with the first AP) for CSR. If the first AP is a sharing AP, the first AP may transmit (broadcast) an SP announcement that indicates one or more final lists of APs generated by the first AP to the plurality of APs and one or more reuse SPs, and APs included in the one or more final lists may communicate with respective STAs during the reuse SPs based on receiving the SP announcement.

In some examples, the first AP (and each AP of multiple APs) may classify each of the other APs as either a compatible AP (an AP compatible with the first AP for CSR, a reuse SP) or an incompatible AP (an AP incompatible with the first AP for CSR) based on monitoring a signal strength (interference signal strength) associated with each of the other APs. The first AP may obtain (determine, be configured with) a threshold signal strength, and APs associated with a signal strength that satisfies the threshold signal strength may be classified as incompatible with the first AP for CSR, while APs associated with a signal strength that does not satisfy the threshold signal strength may be classified as compatible with the first AP for CSR. As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Additionally, each AP of the multiple APs may classify one or more STAs associated with the AP as either inner clients or outer clients, where inner clients may communicate during the reuse SPs. The sharing AP also may indicate (such as via the SP announcement) one or more rules for communicating during the reuse SPs, such as network allocation vector (NAV) rules allowing APs indicated in the final list of APs to ignore a channel occupancy time period (such as a NAV period) associated with other APs indicated in the final list of APs.

Particular aspects of the subject matter described in this disclosure can be implemented to realize one or more of the following potential advantages. In some examples, communicating final lists of APs that are compatible for CSR within an SP announcement may reduce interference levels experienced by APs sharing a reuse SP indicated by the SP announcement. For example, APs indicated by the final list of APs may share the reuse SP (and other APs may not share the reuse SP), reducing interference and increasing throughput associated with the reuse SP. For example, the techniques described herein may increase the throughput by increasing an amount of time for CSR communications via multiple APs without increasing (or possibly while decreasing) interference levels (which otherwise may counteract or negate throughput gains).

Additionally, by restricting a usage of a reuse SP to APs indicated by a final list of APs, the NAV rules associated with the reuse SP may be ignored, which may reduce signaling overhead, latency, and complexity for APs to utilize reuse SPs. For example, APs communicating in a reuse SP based on being indicated by a final list of APs may ignore one or more channel occupancy time periods (such as NAV period) associated with other APs on the final list of APs, reducing latency and signaling overhead during the reuse SP. Additionally, ignoring NAV rules may relieve APs from quickly determining whether or not to join the reuse SP (making scheduling decisions on the fly, using processing power), as the NAV rules may no longer restrict the APs from joining, which may reduce the complexity for the APs to utilize the reuse SPs.

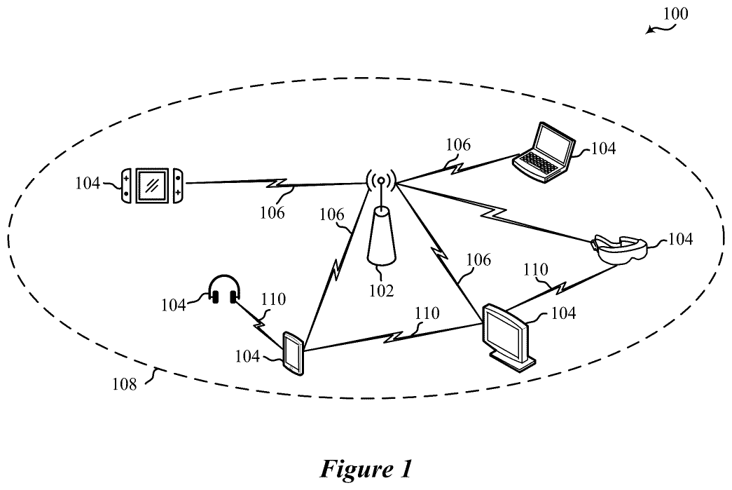

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102.

FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

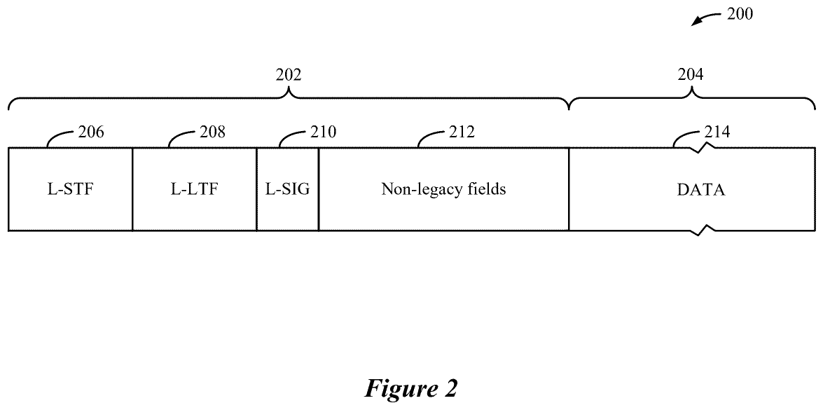

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

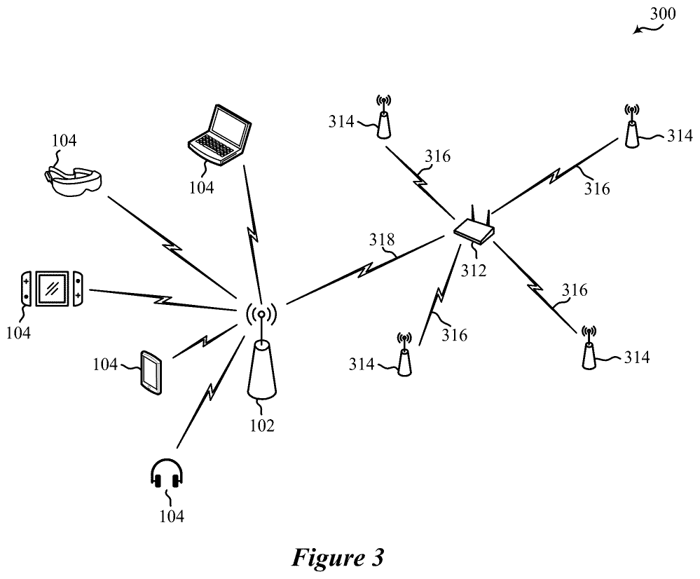

FIG. 3 shows a pictorial diagram of another example wireless communication network 300. According to some aspects, the wireless communication network 300 can be an example of a mesh network, an IoT network, or a sensor network in accordance with one or more of the IEEE 802.11 family of wireless communication protocol standards (including the 802.11ah amendment). The wireless communication network 300 may include multiple wireless communication devices 314, which in some implementations may include APs 102, STAs 104, or both. The wireless communication devices 314 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 314 sense, measure, collect or otherwise obtain and process data and transmit such raw or processed data to an intermediate device 312 for subsequent processing or distribution. Additionally, or alternatively, the intermediate device 312 may transmit control information, digital content (such as audio or video data), configuration information or other instructions to the wireless communication devices 314. The intermediate device 312 and the wireless communication devices 314 can communicate with one another via wireless communication links 316. In some examples, the wireless communication links 316 include Bluetooth links or other PAN or short-range communication links.

In some examples, the intermediate device 312 also may be configured for wireless communication with other networks such as with a WLAN or a wireless (such as cellular) wide area network (WWAN), which may, in turn, provide access to external networks including the Internet. For example, the intermediate device 312 may associate and communicate, over a Wi-Fi link 318, with an AP 102 of a wireless communication network 300, which also may serve various STAs 104. In some examples, the intermediate device 312 is an example of a network gateway, for example, an IoT gateway. In such a manner, the intermediate device 312 may serve as an edge network bridge providing a Wi-Fi core backhaul for the IoT network including the wireless communication devices 314. In some examples, the intermediate device 312 can analyze, preprocess and aggregate data received from the wireless communication devices 314 locally at the edge before transmitting it to other devices or external networks via the Wi-Fi link 318. The intermediate device 312 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures.

Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

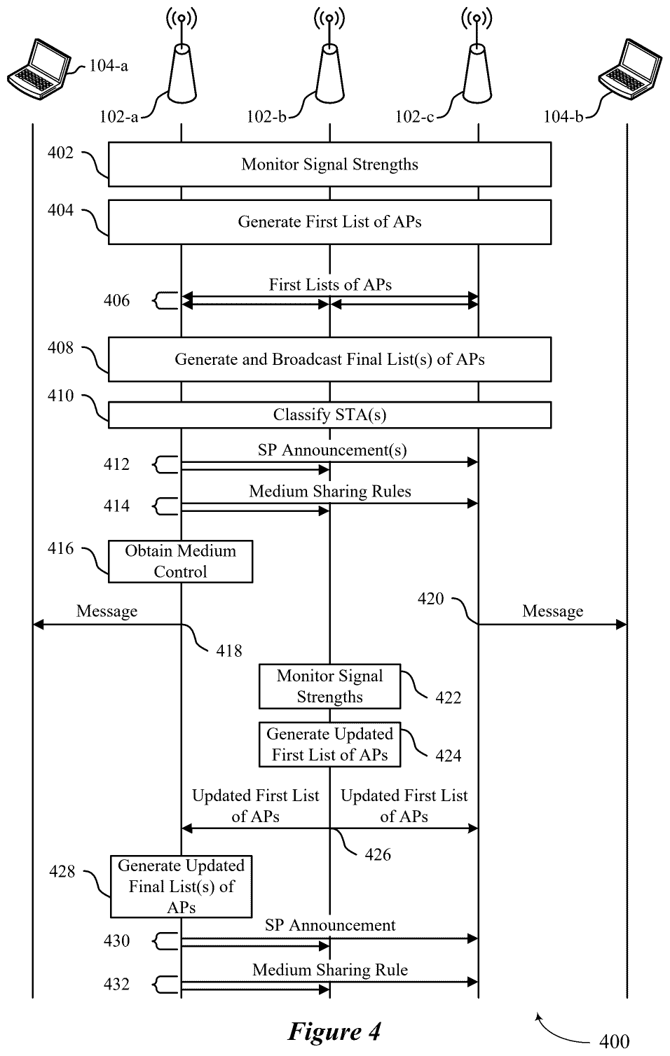

FIG. 4 shows an example of a process flow 400 that supports CSR with restricted medium sharing. Some aspects of the process flow 400 may implement or be implemented by aspects of FIG. 1 -3. For example, the process flow 400 may include APs 102 (such as an AP 102-a, and AP 102-b, and AP 102-c) and a STAs 104 (such as a STA 104-a and a STA 104-b), which may be examples of APs 102 and STAs 104, respectively, as described herein with respect to FIG. 1 -3. In some aspects, the APs 102 may each generate a respective first list of APs, share the first lists of APs with each other AP 102, and generate respective final list(s) of APs (one or more final lists of APs) based on the first lists of APs. Additionally, a sharing AP (such as the AP 102-a) may share a reuse SP with shared APs 102 (such as the APs 102-b and 102-c) based on the final list(s) of APs generated by the sharing AP.

In some examples, APs 102 and the STAs 104 may support CCA rules and unregulated medium reuse. For instance, in a multi-AP deployment, medium access may be carefully regulated to avoid high interference scenarios across adjacent BSSs. In such cases, one or more CCA rules may define an energy detection (ED) threshold. If a detected power or energy based on sensing the medium (such as by one or more APs 102) may indicate that the medium is busy (occupied, owned, currently accessed by another AP 102) and transmissions may be deferred (such as for a duration of time). However, applying the ED threshold value (which may be defined by an industry standard) may not guarantee exclusive medium access to one BSS at a time. Thus, some medium reuse may occur and, in some cases, multiple OBSSs may impose relatively high interference levels on each other (resulting in degraded system performance).

Additionally, in some scenarios (such as in 40 MHz multi-BSS), a reduction in an average throughput rate (in terms of megabits per second) may occur when one or more APs 102 are placed far enough away from each other (such as outside a threshold distance). For instance, the one or more APs may be spaced far enough to have mutual RSSI values that are lower than the ED threshold. As distance between the one or more APs 102 increases, interference levels may decrease, and an average throughput rate may converge (such as to a full rate). However, some operating conditions, such as when two APs 102 measure an energy that is just below (such as within a threshold quantity of) the ED threshold, the two APs may concurrently gain unregulated access to the wireless medium, which may result in relatively high interference thereby reducing data throughput rates of the system.

Accordingly, CSR procedures may be used to regulate the medium access (such as when a received signal power is below the ED threshold). CSR may enable an AP 102 that owns the medium access (such as an AP that gains access first) to share it with one or more other APs 102 (such as to increase system capacity). That is, an AP 102 may perform a channel access procedure (such as a contention based procedure) to access a wireless medium (such as a communication channel) and may gain access (or “own” access, obtain medium control) to the channel for a duration (a medium ownership duration) based on performing the channel access procedure. In some examples, the AP 102 that owns the medium access may be referred to as a “sharing AP,” and the one or more APs 102 sharing the medium with the sharing AP may be referred to as one or more “shared APs.” In some examples, based on a channel measurement (an energy measurement of the medium) and using STA scheduling, a sharing AP 102 and/or a shared AP 102 may decide whether to share the medium. When a measured interference is below a threshold (a low interference scenario), the APs 102 may share the medium. When the measured interference is above a threshold (in a high interference scenario), the APs 102 may not share the medium. In some examples, the APs 102 may determine that the measured interference level satisfies (or fails to satisfy) the threshold based on one or more rules announced by the sharing AP 102 (such as the medium sharing rules described at 416).

In some cases, the devices in the process flow 400 may support target wake time (TWT) techniques. For instance, TWT may enable power saving at the APs 102 and the STAs 104 to by sharing their expected wake time with other devices and avoiding continuous monitoring of the medium. In some examples, an AP 102 or a STA 104 may utilize a restricted TWT (rTWT) to further improve the usage of network resources. For instance, an AP 102 (such as an SP owner) may reserve resources by announcing rTWT SPs that are dedicated to the AP 102. In some examples, APs 102 may use rTWT for serving latency sensitive traffic, which may have predictable patterns, where the APs 102 may use rTWT to preschedule SPs dedicated to serve such traffic. Further, rTWT may operate on a BSS level, and there may be no guarantee that rTWT SPs are respected (or recognized) across BSSs (such as between respective communications associated with multiple APs 102).

The devices of the process flow 400 may further utilize a Coordinated-rTWT (C-rTWT) as an extension of rTWT. For example, C-rTWT may configure a BSS to respect (or refrain from transmitting during) one or more SPs associated with another BSS, thus prioritizing (such as exclusive, more likely, less interrupted) medium access for one BSS without having interference from one or more OBSSs. Accordingly, C-rTWT may be suited for AP-level coordination schemes, which may operate based on (or on top of) C-rTWT. For instance, CSR and Coordinated-TDMA (C-TDMA) may be examples of AP-level coordination features that utilize C-rTWT.

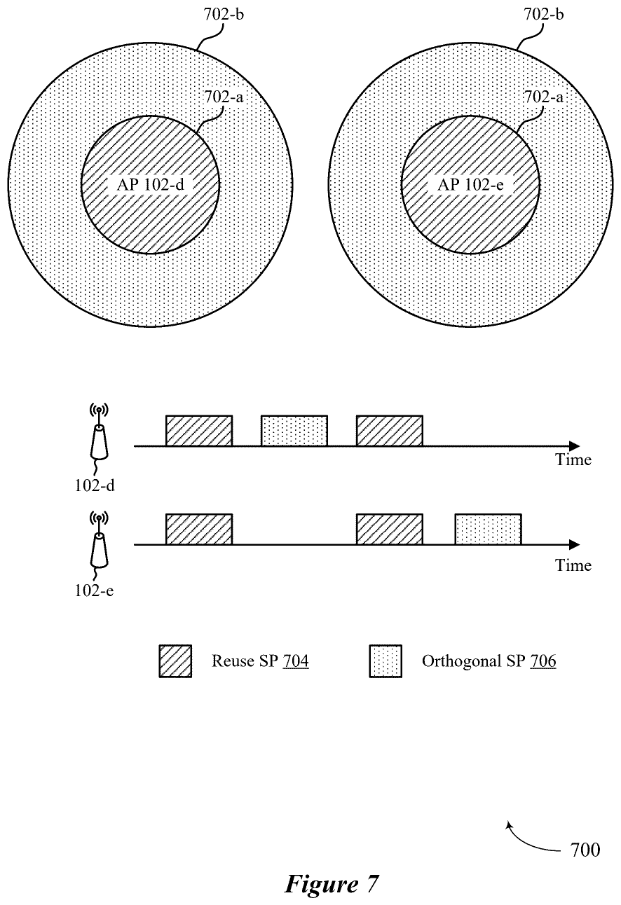

The process flow 400 may implement an SP-based CSR framework to reduce complexity and time constraints associated with shared APs. In SP-based CSR, an AP (such as the AP 102-a, a sharing AP) may define a reuse SP (such as a C-rTWT SP, a period of wireless medium for concurrent communications by different APs 102) and broadcast the details of the reuse SP for other APs 102 to be able to share the reuse SP. The AP may announce reuse SPs is SP announcements that may use management-level signaling (such as beacon frames or any other management frames). In addition to the reuse SPs, the sharing AP may define orthogonal SPs that may not be offered for sharing with other APs 102. For example, the sharing AP may serve a set of clients that are vulnerable to interference (such as outer clients, described herein with respect to FIG. 7) during orthogonal SPs.

In some examples, the sharing AP may enforce sharing rules associated with the reuse SPs, where the sharing rules may not allow high interference shared APs (such as APs 102 with RSSI measurements that satisfy a threshold) to share the reuse SP. Some examples of sharing rules may include setting a threshold level of interference (such as a maximum RSSI value), enforcing a threshold AP-to-AP RSSI (such as a maximum AP to AP RSSI), specifying a set of APs permitted to use the reuse SP, or the like, or any combination thereof.

In such cases of medium sharing and reuse, CCA and EDCA rules may prevent one OBSS from performing communications at a same time as another OBSS's transmission. However, such rules may not guarantee exclusive access and may result in relatively high interference levels experienced by an AP 102 during a reuse SP. A reuse factor of the medium may indicate a quantity of devices (such as APs 102, STAs 104, or both) that are communicating via the medium during a period of time, where a higher reuse factor may correspond to an increased aggregate medium throughput levels. In some examples, a relatively high reuse factor of the medium may compensate for high interference levels, however, the high interference levels may prevent other APs 102 from reusing the medium. For instance, a highest interfering AP may dominate an aggregate interference level experienced by an AP 102 (such as a sharing AP), where the highest interfering AP may be relatively close to the AP 102, associated with an RSSI that exceeds a threshold, or both. In other words, one or more other APs (more OBSSs) that may potentially share the medium may not significantly increase the interference experienced by the AP 102 and may increase the reuse factor of the medium.

One or more techniques described herein may increase a quantity of APs 102 that may share the medium with a sharing AP (such as AP 102-a) while controlling interference by selecting one or more APs 102 with which to share the medium (selection of one or more shared APs). For example, the selection of the one or more shared APs may increase a likelihood that each shared AP does not cause high interference for the other shared APs. In examples where a sharing AP dictates which shared APs are to use a medium (such as in a restricted medium sharing CSR system), the sharing AP may collect information about candidate shared APs (such as APs 102-b and 102-c) in order to group compatible APs 102 together to operate as shared APs concurrently or simultaneously. The techniques herein may provide a CSR framework to achieve such an effect.

In the following description of process flow 400, the operations may be performed in a different order than the order shown, or other operations may be added or removed from the process flow 400. For example, some operations also may be left out of process flow 400, may be performed in different orders or at different times, or other operations may be added to process flow 400. Although the APs 102 and the STAs 104 are shown performing the operations of process flow 400, some aspects of some operations also may be performed by one or more other wireless devices or network devices. Additionally, although a quantity of APs 102 and STAs 104 are depicted in the process flow 400, the techniques described herein may apply to any quantity of APs 102, STAs 104, or both.

At 402, each of the APs 102 (one or more of AP 102-a, AP 102-b, and AP 102-b, multiple APs 102) may monitor a strength of one or more signals corresponding to one or more APs (such as the other APs 102). For example, AP 102-a may monitor a strength of one or more signals associated with AP 102-b, AP 102-c, one or more other APs 102, or any combination thereof. For example, each AP 102 may monitor (or measure) a received signal strength indicator (RSSI) level (such as an interference level) associated with each other AP 102. In some examples, RSSI measurements may be based on general or specific-purpose broadcast frames, such as beacon frames or other frames sent for RSSI measurements. For example, each AP 102 may transmit (such as broadcast, unicast) one or more frames on which the other APs 102 may monitor RSSI levels for the AP 102.

At 404, each AP 102 may generate, based on a strength of the one or more signals (RSSI levels) and a threshold signal strength, a first list of APs. For example, a first list of APs associated with the AP 102-a may indicate which of one or more APs 102 within a network or BSS (including APs 102-b and 102-c) is compatible with the AP 102-a for CSR, which of the one or more APs 102 is incompatible with the AP 102-a for CSR, or both. For example, each AP 102 may compare the monitored (measured) signal strengths (RSSI levels) to the threshold signal strength (such as a threshold value RSSI_Th), and may classify APs 102 based on whether an associated signal strength satisfies the threshold signal strength. For example, the AP 102-a may classify APs 102 associated with signal strengths that satisfy the threshold signal strength as high interference APs (incompatible), and may classify APs 102 associated with signal strengths that do not satisfy the threshold signal strength as low interference APs (compatible).

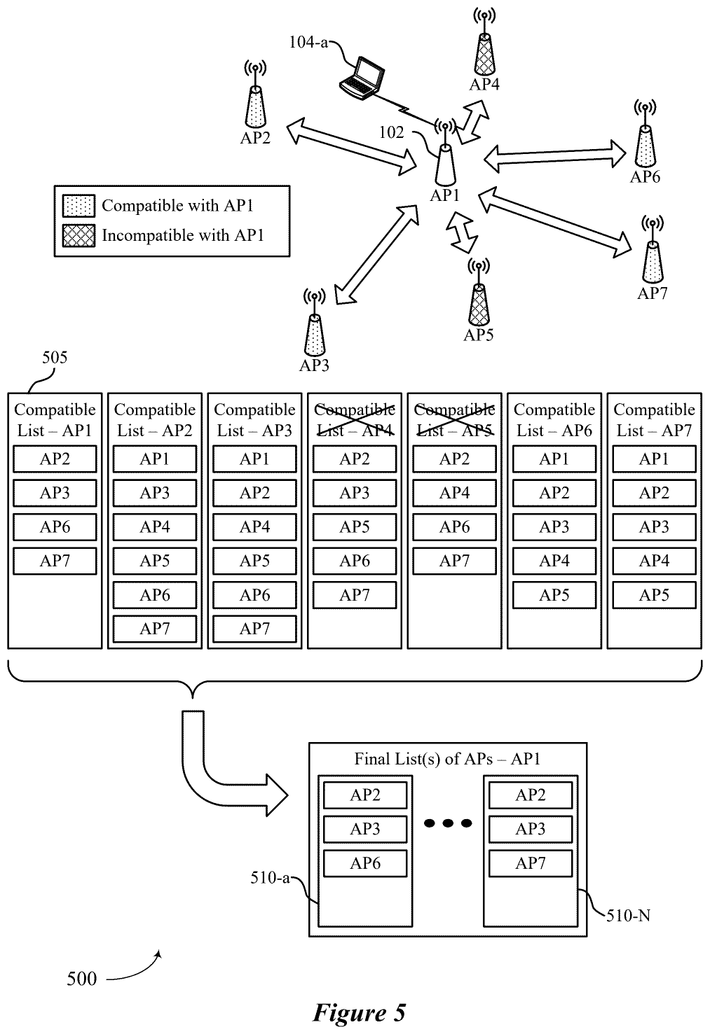

In one example, the first list of APs generated by each AP may be a compatible list. A compatible list associated with an AP 102 may indicate all APs 102 (within a BSS or a network) that the AP 102 is compatible with for concurrent or simultaneous data transmission (such as CSR) based on monitored signal strength and the threshold signal strength (such as all reuse SPs, all low interference APs, APs 102 with which the AP 102 is allowed to share SPs). In some examples, FIG. 5 may further describe compatible lists and the use thereof.

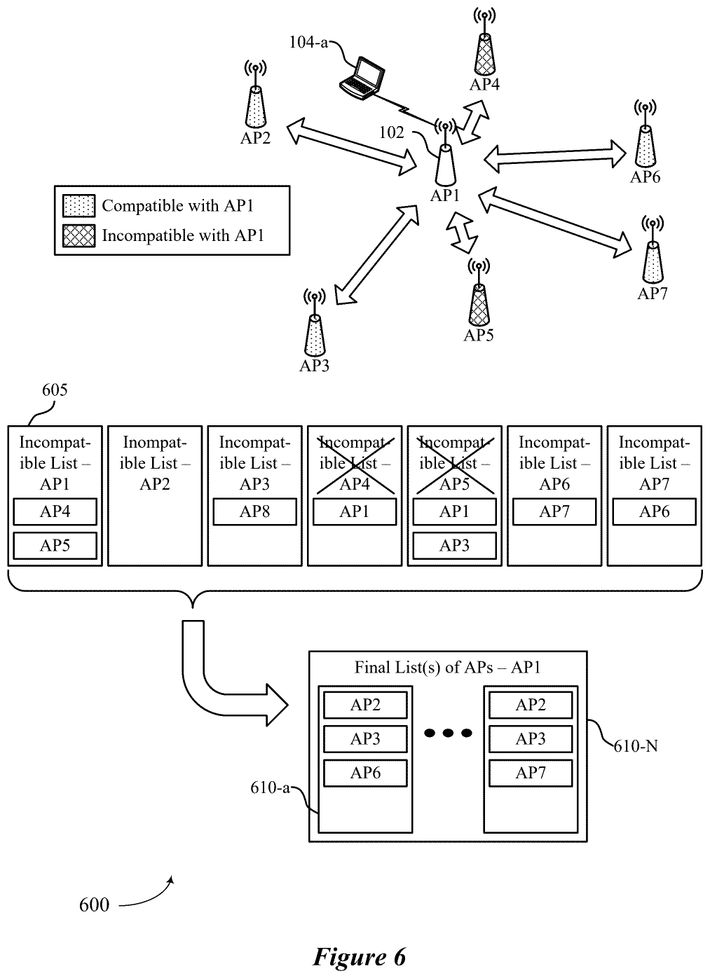

Additionally, or alternatively, the first list of APs generated by each AP may be an incompatible list. An incompatible list associated with an AP 102 may indicate all APs 102 that the AP 102 is incompatible with for concurrent or simultaneous data transmission (such as CSR) based on monitored signal strength and the threshold signal strength (non-reuse SPs, all high interference APs, APs 102 with which the AP 102 is not allowed to share SPs). In some examples, FIG. 6 may further describe incompatible lists and the use thereof.

In some examples, each AP 102 may be associated with a respective threshold signal strength. For example, a threshold signal strength associated with the AP 102-a may be the same as or different than one or more second threshold signal strengths associated with the APs 102-b and 102-c. In some examples, the APs 102 may select a threshold signal strength to use in the generation of the first lists of APs based on combined interference levels at the AP 102 or one or more other factors. In other words, a beacon power-based sharing AP classification may be performed, where based on RSSI, each AP classifies its neighbor APs into two classes: (1) a Reuse AP: a neighbor AP that a sharing AP allows to use a reuse SP owned by the sharing AP, and (2) a non-reuse AP: a neighbor AP that a sharing AP does not allow to use a reuse SP owned by the sharing AP.

At 406, each AP 102 may receive the first lists of APs from multiple other APs 102 (such as list sending APs). For example, each AP 102 may transmit (broadcast) a first list of APs associated with the AP 102, and each other AP 102 may receive the first lists of APs associated with each AP 102. From the point of view of AP 102-a, each of APs 102-b and 102-c may be referred to as list sending APs, where a list sending AP may correspond to the first list of APs that it sent.

The first lists of APs may be communicated via various frames. For example, each AP 102 may receive the first lists of APs within one or more beacon frames, one or more reduced neighbor report (RNR) information elements, one or more information elements associated with communication of first lists of APs, one or more action frames associated with communication of first lists of APs (such as with an action associated with communication of first lists of APs), one or more broadcast management frames, or any combination thereof.

In some examples, an AP 102 may be hidden from another AP 102. For example, AP 102-c may be hidden from (such as not in contact with, out of range of) the AP 102-a due to distance, obstacles, radio interference, or other factors. In such examples, the AP 102-a may receive a first list of APs from AP 102-b (an intermediate AP 102 which may not be hidden from AP 102-a or AP 102-c) that indicates the AP 102-c (either as compatible with AP 102-b or incompatible with AP 102-b). The AP 102-a may not be aware of the AP 102-c from the first list of APs associated with AP 102-b based on AP 102-c being a node that is hidden from AP 102-a, and the APs 102 may accordingly repeat transmission of the first lists of APs a quantity of times. For example, transmission of the first lists of APs may be repeated until all first lists of APs (associated with APs 102 within a network, a BSS, or a CSR BSS operating group) propagate to all APs 102 (within the network, BSS, or CSR BSS operating group).

At 408, each AP 102 may combine (iteratively combine, in the example of hidden APs 102) the received first lists of APs to generate one or more final lists of APs (list of friendly shared APs), and may transmit (broadcast) the one or more final lists of APs to the other APs 102. That is, each AP 102 may monitor (track) the transmitted first lists of APs associated with the other APs 102 (neighbor APs) and may create or update one or more final lists of APs indicating one or more APs 102 that are compatible to communicate simultaneously (such as using CSR). For example, a final list of APs associated with the AP 102-a may indicate a set of one or more APs 102 (of multiple APs 102 including the APs 102-b and 102-c), where each AP 102 of the set may be compatible with the AP 102-a and with each other AP 102 of the set for CSR within an SP. Each final list of APs associated with an AP 102 may contain a different set of APs 102 (different subsets of the APs 102), and the different sets of APs may overlap with each other at least partially. In one example, a final list of APs associated with AP 102-a may indicate AP 102-c as compatible but may not indicate AP 102-b as compatible. In some aspects, FIGS. 5 and 6 may further describe examples for generation and use of the final lists of APs in the context of compatible lists and incompatible lists, respectively. In other words, as part of CSR neighbor AP list advertisement, each AP (such as a list sending AP) broadcasts its own one or more CSR list(s) so that other APs may iteratively combine broadcasted lists to converge on one or more lists of friendly shared APs (e.g., final lists). As part of CSR shared APs list creation and/or updating of a CSR shared AP list, each AP may track the announced CSR list of neighbor APs and create, update, or both, multiple lists of neighbor APs that may operate simultaneously within a reuse SP.

After generation of the one or more final lists of APs, each AP may broadcast the one or more final lists of APs to each other AP 102 (within a network, within a BSS). In some examples, each AP may broadcast the one or more final lists of APs in response to generating the one or more final lists of APs, at 414 (with medium sharing rules), or both.

At 410, the APs 102 may classify one or more STAs 104 (perform a client classification procedure). For example, the AP 102-a may classify the STA 104-a (and one or more other STAs associated with the AP 102-a) as either an inner client or an outer client. In some examples, inner clients may be STAs 104 (clients) that may experience a relatively high signal to interference and noise ratio (SINR) (such as a SINR higher than a threshold SINR) due to, for example, being located physically closer to a serving AP. Outer clients may be STAs 104 that may experience relatively low SINR due to, for example, being physically located farther away from a serving AP or being an edge client. Additionally, inner clients may be physically located closer to an associated AP 102 than outer clients. In some examples, the AP 102-a may classify the STA 104-a as an inner client, and the AP 102-c may classify the STA 104-b as an inner client. In some aspects, classification of the STAs 104 may be further described with respect to FIG. 7.

At 412, the AP 102-a may transmit (e.g., broadcast) an SP announcement (a reuse SP announcement) that indicates a first reuse SP (or any other SP) and a first final list of APs associated with (generated by) the AP 102-a. In some examples, each AP 102 may define one or more reuse SPs, one or more orthogonal SPs, or both, associated with the medium. For example, reuse SPs may be one or more periods (periodic resources) for concurrent or simultaneous communication (such as CSR) of the APs 102 with associated STAs 104, and orthogonal SPs may be one or more periods dedicated to one or more AP 102 for communication with one or more associated STAs 104. In some examples, an AP 102 may choose to share the medium during an entire medium ownership duration (described at 416), such that the AP may define reuse SPs but not define orthogonal SPs. In some examples, as part of an SP Announcement, at least one or up to each AP 102 may define at least one reuse SP, at least one orthogonal SP, or both, where a reuse SP may be announced for reuse among other APs. Additionally, at least one or up to each AP 102 also may indicate or otherwise announce, in the SP announcement, a set of one or more medium sharing rules (described at 414) that any shared AP is to follow when using an SP owned by the AP associated with the SP. Additionally, one or more APs 102 may indicate or otherwise announce, in the SP announcement, the list of one or more shared APs that are permitted to use the medium during the one or more announced reuse SPs (a final list of APs).

Additionally, or alternatively, the AP 102-a may transmit a second SP announcement that indicates a second reuse SP and a second final list of APs associated with the AP 102-a. In some examples, the second final list of APs may differ from the first final list of APs, and both the first final list of APs and the second final of APs may be generated at 408 at different times or during at least partially overlapping times. For example, at least one AP 102 indicated by the second final list of APs may be incompatible for CSR with at least one AP 102 indicated by the first final list of APs. In some examples, each SP announcement also may indicate a duration of the respective reuse SP, a start time, an end time, or any combination thereof. The AP 102-a may transmit (broadcast) the SP announcement using management-level signaling, such as beacon frames or other broadcasting frames. One or more other AP 102 also may transmit (e.g., broadcast) such an SP announcement.

At 414, the AP 102-a also may transmit (broadcast) an indication of one or more medium sharing rules (SP sharing rules), where communication of messages within a reuse SP indicated in the SP announcement(s) may be based on the one or more medium sharing rules. The medium sharing rules may be a set of one or more rules that any shared AP may follow while communicating using the reuse SPs indicated in the SP announcement(s). For example, the AP 102-a may transmit (such as enforce) the indication of the medium sharing rules before or during the medium-owned time (such as if the AP 102-a defines reuse SPs and not orthogonal SPs) based on detecting high interference from shared APs that may share a reuse SP. In some examples, the one or more medium sharing rules may include one or more NAV rules, as described herein at 418. Additionally, or alternatively, transmitting the indication of the one or more medium sharing rules may include transmitting the final list(s) of APs as discussed at 408. One or more other APs also may transmit (broadcast) such an indication of one or more medium sharing rules.

At 416, the AP 102-a may obtain control or ownership of a medium for a medium ownership duration (such as a transmission opportunity (TxOP), one or more wireless resources including frequency and time resources). For example, the APs 102 may compete for ownership of the medium (perform CCA or other channel access procedure attempting to obtain access to a wireless medium), and the AP 102-a may gain ownership of the medium. Based on gaining ownership of the medium, the AP 102-a may be a sharing AP and the other APs 102 (such as the APs 102-b and 102-c) may be one or more shared APs.

At 418, the AP 102-a and the AP 102-c (one or more shared APs indicated by the first or second final lists of APs) may (simultaneously) communicate messages during the announced reuse SPs. That is, APs 102 indicated by a final list of APs indicated in a SP announcement(s) may be allowed to communicate during a reuse SP indicated by the SP announcement (and other APs 102 may not be allowed). For example, the AP 102-a may communicate, within a reuse SP, a first message with the STA 104-a (which may be associated with the AP 102-a). At 420, either concurrently with 418 or at a different time during the reuse SP, the AP 102-c may communicate a second message with the STA 104-b based on being indicated in the announced final list of APs associated with the reuse SP. In some examples, the AP 102-a may communicate the first message with the STA 104-a within the reuse SP based on having classified the STA 104-a as an inner client (such as at 408, further described herein with respect to FIG. 7). In some examples, AP 102-b may refrain from communicating with one or more STAs 104 during the reuse SP based on not being indicated in the final list of APs.

Additionally, or alternatively, the AP 102-a may communicate the first message with the STA 104-a based on ignoring a channel occupancy time period (a NAV period) associated with the second message. For example, the second message may indicate a channel occupancy time period. Instead of backing off (refraining from communicating) during the channel occupancy time period indicated by the second message, the AP 102-a may communicate with the STA 104-a during the reuse SP that at least partially overlaps with the channel occupancy time, effectively ignoring the channel occupancy time. In some cases, this may be based on one or more NAV rules corresponding to the CSR framework described herein, and the NAV rules may be indicated at 416. For example, the NAV rules may indicate that the AP 102-a (a sharing AP) may ignore a channel occupancy period associated with any shared AP indicated by the final list of APs (such as the AP 102-c), and that shared APs indicated by the received final list of APs may ignore the channel occupancy period associated with AP 102-a (the sharing AP) and other shared APs indicated by the final lists of APs announced by AP 102-a. Thus, the APs on the final list may ignore the NAV rules during the reuse SP and may communicate with one or more other STAs that overlaps with each other AP's indicated channel occupancy time. Additionally, or alternatively, communication of the messages at 418 and 420 (concurrently, at least partially overlapping in time, or at different times) within the reuse SP may be based on the one or more medium sharing rules.

At 422, the AP 102-b may monitor one or more signal strengths (RSSIs), similar to the operation at 402. At 424, the AP 102-b may generate an updated first list of APs associated with the AP 102-b based on the monitoring at 422. For example, one or more APs 102 may be removed from or added to a first list of APs associated with the AP 102-b based on the monitoring at 422. At 426, one or more APs 102 (such as the APs 102-a, 102-c, or both) may receive the updated first list of APs from the AP 102-b.

At 428, in response to receiving the updated first list, the AP 102-a may generate one or more updated final lists of APs based on the previously received first lists of APs (as described at 406) and the updated firs list of APs. At 430, the AP 102-a may transmit another one or more SP announcements that indicate one or more reuse SPs and the one or more updated final lists of APs. Additionally, at 432, the AP 102-a may transmit (broadcast) one or more medium sharing rules (such as described at 414) associated with the SP announcement at 430. In some examples, one or more of the APs 102 may communicate on the indicated one or more reuse SPs based on the updated final lists of APs and the one or more medium sharing rules (as described herein).

Thus, generating the first lists of APs, communicating the first lists of APs, and generating the final lists of APs may allow one or more of the APs 102 to communicate during a reuse SP with less interference. For example, the SP announcement indicating the final lists of APs may prohibit high interference APs from communicating during the reuse SP. Such reduction in interference may increase an efficiency and throughout of communication in a wireless communications system that includes the APs 102.

FIG. 5 shows an example of a wireless communications system 500 that supports CSR with restricted medium sharing. In some examples, aspects of the wireless communications system 500 may implement or be implemented by aspects of FIG. 1-4. For example, the wireless communications system 500 may include one or more APs 102 (such as the APs 102 described herein with respect to FIG. 1-4), one or more STAs 104 (such as the STA 104 described herein with respect to FIG. 1-4), first lists of APs 505 (as described herein with respect to FIG. 1-4), and final list(s) of APs 510 (second lists of APs, final lists of APs described herein with respect to FIG. 1-4). The one or more APs 102 may be referred to as AP1, AP2, AP3, AP4, AP5, AP6, and AP7 (the APs 102, or AP1 through AP7). In the wireless communications system 500, each first list of APs 505 may be a compatible list (as described with respect to FIG. 4), and each AP 102 of the wireless communications system 500 may receive the first lists of APs 505 and generate one or more final list(s) of APs 510 based on the first lists of APs 505.

As described with respect to FIG. 4, each AP 102 may use AP classification criterion (such as the RSSI levels and a respective threshold signal strength) to create a respective first list of APs 505 (a compatible list in the example of the wireless communications system 500). For example, AP1 (and each other AP 102) may create a compatible list (a permitted list, “Compatible List—AP1”) that may indicate each AP 102 from AP2 through AP7 (the other APs 102) for which a monitored (measured) RSSI does not exceed a threshold signal strength associated with the AP1, and thus may be compatible with AP1 for CSR. As an example, AP1 may determine that RSSIs associated with AP4 and AP5 exceed a threshold signal strength associated with the AP1, and thus AP1 may include AP2, AP3, AP6, and AP7 in a compatible list. Other first lists of APs 505 (“Compatible List—AP2” through “Compatible List—AP7”) may be examples of possible compatible lists for each AP 102 in the wireless communications system 500.

After communicating each first list of APs 505 with each AP 102, each AP 102 may create (or update) one or more final lists of APs 510, where each AP 102 in a final list of APs 510 may be compatible with each other AP 102 in the final list of APs and the sharing AP (such as AP1) to communicate in a reuse SP according to CSR. For example, AP1 may iteratively combine the first lists of APs 505 associated with AP1 through AP7 to create one or more final lists of APs 510 (such as a final list of APs 510-a through a final list of APs 510-N, where N may be any positive integer), where each final list may indicate a different set of APs 102 (that may at least partially overlap).

AP1 (and each AP 102) may perform a procedure to create the one or more final lists of APs 510 based on the first lists of APs 505 (the compatible lists). In one example of the procedure, AP1 may discard each first list of APs 505 that is associated with an AP 102 that is not compatible with AP1 (not on the first list of APs 505 associated with AP1, discarding the first lists of APs 505 corresponding to AP4 and AP5, as indicated by the crossing out). Additionally, AP1 may discard any first lists of APs 505 in which AP1 does not appear (none shown). From the remaining first lists of APs 505 (associated with AP1, AP2, AP3, AP6, and AP7), AP1 may create each combination of AP2 through AP7 that does not include any two incompatible APs. For example, AP2 and AP3 may be found in each remaining first list of APs 505 (other than their own), and thus may be compatible with each other, with AP6, and with AP7. However, AP6 and AP7 may not be found in first lists of APs 505 associated with each other. Thus, AP1 may place AP6 and AP7 in different final lists of APs 510, and each final list of APs 510 may include AP2 and AP3. The procedure described herein is merely and in no way limits the techniques described herein.

AP1 through AP7 may utilize the final lists of APs 510 to reduce interference within a reuse SP. For example, the AP1 (a sharing AP) may transmit an SP announcements that indicates a final list of APs 510 and a reuse SP, and APs 102 on the final list of APs may communicate with respective STAs 104 during the reuse SP (such as CSR). Because the APs 102 indicated by the final lists of APs 510 may be compatible with one another, APs 102 communicating during the reuse SP may experience reduced interference compared to other CSR frameworks.

FIG. 6 shows an example of a wireless communications system 600 that supports CSR with restricted medium sharing. In some examples, aspects of the wireless communications system 600 may implement or be implemented by aspects of FIG. 1-5. For example, the wireless communications system 600 may include one or more APs 102 (such as the APs 102 described herein with respect to FIG. 1-5), one or more STAs 104 (such as the STA 104 described herein with respect to FIG. 1-5), first lists of APs 605 (as described herein with respect to FIG. 1-6), and final list(s) of APs 610 (second lists of APs, final lists of APs described herein with respect to FIG. 1-6). The one or more APs 102 may be referred to as AP1 through AP7. In the wireless communications system 600, the first lists of APs 605 may be incompatible lists, and each AP 102 of the wireless communications system 600 may receive the first lists of APs 605 and generate the final list(s) of APs 610 based on the first lists of APs 605.

As described with respect to FIG. 4, each AP 102 may use AP classification criterion (such as the RSSI levels and a respective threshold signal strength) to create a respective first list of APs 605 (an incompatible list in the example of the wireless communications system 600). For example, AP1 (and each other AP 102) may create an incompatible list (a prohibited list, “Incompatible List—AP1”) that may indicate each AP 102 from AP2 through AP7 (the other APs 102) for which a monitored (measured) RSSI exceeds a threshold signal strength associated with the AP1, and thus may be incompatible with AP1 for CSR. As an example, AP1 may determine that RSSIs associated with AP4 and AP5 exceed the threshold signal strength associated with the AP1, and thus may include AP4 and AP5 in the incompatible list. Other first lists of APs 605 (“Incompatible List—AP2” through “Incompatible List—AP7”) may be examples of possible incompatible lists for each AP 102 in the wireless communications system 600.

After communicating each first list of APs 605 with each AP 102, each AP 102 may create (or update) one or more final lists of APs 610, where each AP 102 in a final list of APs 610 may be compatible with each other AP 102 in the final list of APs and the sharing AP (such as AP1) to communicate in a reuse SP according to CSR. For example, AP1 may iteratively combine the first lists of APs 605 associated with AP1 through AP7 to create one or more final lists of APs 610 (such as a final list of APs 610-a through a final list of APs 610-N, where N may be any positive integer), where each final list of APs 510 may indicate a different set of APs 102 (that may at least partially overlap).

AP1 (and each AP 102) may perform a procedure to create the one or more final lists of APs 610 based on the first lists of APs 605 (the incompatible lists). In one example of the procedure, AP1 may discard each first list of APs 605 that is associated with an AP 102 that is incompatible with AP1 (that is on the first list of APs 605 associated with AP1, discarding the first lists of APs 605 corresponding to AP4 and AP5, as indicated by the crossing out). Additionally, AP1 may discard any first lists of APs 605 in which AP1 appears (AP4 and AP5). From the remaining first lists of APs 605 (associated with AP1, AP2, AP3, AP6, and AP7), AP1 may create each combination of AP2 through AP7 that does not include any two incompatible APs. For example, AP2 and AP3 may be absent from each remaining first list of APs 605, and thus may be compatible with each other, with AP6, and with AP7. However, AP6 and AP7 may be found in the first lists of APs 605 associated with each other. Thus, AP1 may place AP6 and AP7 in different final lists of APs 610, and each final list of APs 610 may include AP2 and AP3. The procedure described herein is merely and in no way limits the techniques described herein.

AP1 through AP7 may utilize the final lists of APs 610 to reduce interference within a reuse SP. For example, the AP1 (a sharing AP) may transmit an SP announcements that indicates a final list of APs 610 and a reuse SP, and APs 102 on the final list of APs may communicate with respective STAs 104 during the reuse SP (such as CSR). Because the APs 102 indicated by the final lists of APs 610 may be compatible with one another, APs 102 communicating during the reuse SP may experience reduced interference compared to using other CSR frameworks.

FIG. 7 shows an example of a resource diagram 700 that supports CSR with restricted medium sharing. In some examples, aspects of the resource diagram 700 may implement or be implemented by aspects of FIG. 1-6. For example, the resource diagram 700 may include APs 102 (an AP 102-d, an AP 102-e, such as the APs 102 described herein with respect to FIG. 1-6), reuse SPs 704 (such as the reuse SPs described herein with respect to FIG. 1-6) and orthogonal SPs 706 (dedicated periods, such as the orthogonal SPs described herein with respect to FIG. 1-6). In some aspects, the resource diagram 700 may illustrate resources used to communicate with inner clients associated with inner areas 702-a and outer client associated with outer areas 702-b.

As described with respect to FIG. 4, each AP 102 may categorize associated clients (STAs 104) as either inner clients or outer clients. In some examples, inner clients may experience lower interference levels from neighboring APs 102 (a SINR value, a signal to noise ratio (SNR) value, or an interference level higher than a threshold), and outer clients may experience higher interference levels from neighboring APs 102 (a SINR value, an SNR value, or an interference level lower than the threshold). For example, if an AP 102 is found at the center of the inner area 702-a, inner clients may be within the inner area 702-a and outer clients may be found outside of the inner area 702-a and within the outer area 702-b, since the further a STA 104 is from an associated AP 102 (and the closer the STA 104 is to a neighboring AP 102), the less power signals from the associated AP 102 may be to the STA 104 (and the more powerful signals from the neighboring AP 102 may be to the STA 104). In some examples, each AP 102 may determine the threshold (a threshold SINR, a threshold SNR, a threshold interference level, a threshold radius from an AP 102, or any combination thereof) for determining inner and outer clients, where the threshold may be based on one or more capabilities of the AP 102, among other factors. Additionally, or alternatively, each AP 102 may be configured with a common or unique threshold.

In some examples, APs 102 may schedule communications with inner clients during reuse SPs 704, which may be SPs that are meant to be shared with other APs. Additionally, or alternatively, APs 102 may schedule communications with outer clients during orthogonal SPs 706, which may be SPs when a sharing AP has dedicated medium access. Thus, STAs 104 that may experience less interference during CSR communications (inner clients) may be scheduled for CSR communications, and STAs 104 that may experience higher interference during CSR communications (outer clients) may not be scheduled for CSR communications.

In some examples, instead of classifying STAs 104 and communicating with inner and outer clients in respective SPs, an AP 102 may enforce a stricter threshold signal strength (such as a lower threshold signal strength, a stricter RSSI). A stricter threshold signal strength may exclude more APs 102 from a compatible list (or include more APs 102 in an incompatible list), and may obviate different treatment of inner and outer clients.

Such operations may reduce interference in reuse SPs 704. For example, inner clients may not receive as much interference during reuse SPs 704, and thus scheduling inner clients to communicate during reuse SPs 704 and scheduling outer clients to communicate during orthogonal SPs 706 may reduce interference experienced during the reuse SP 704, increasing communication quality and throughput.

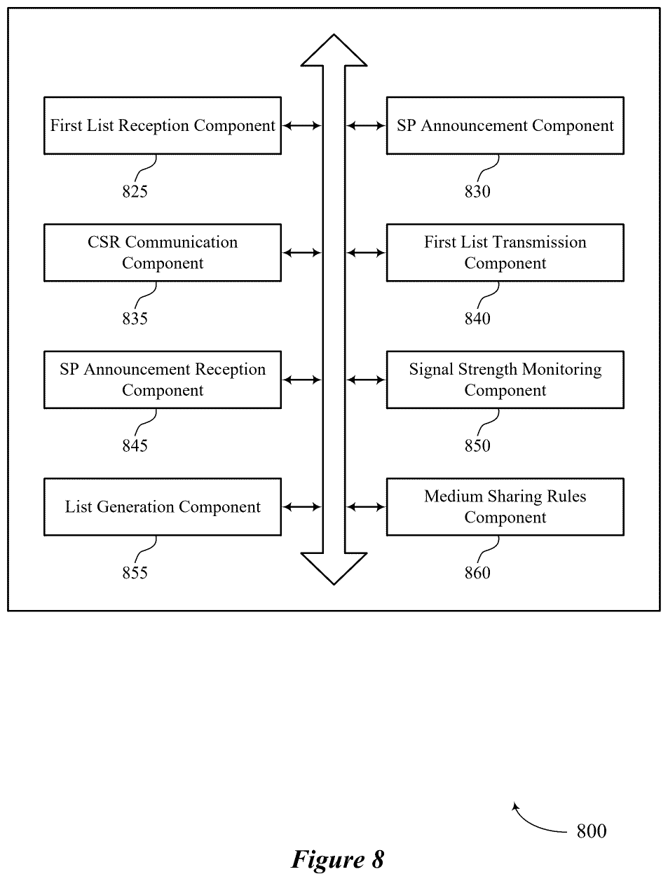

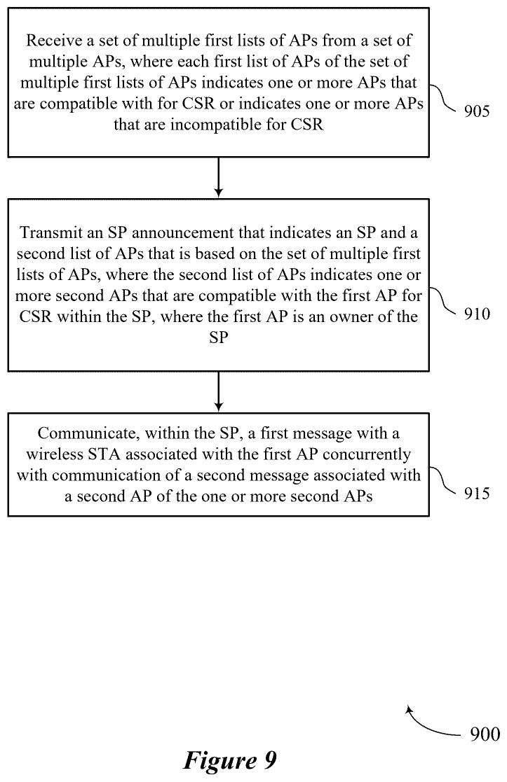

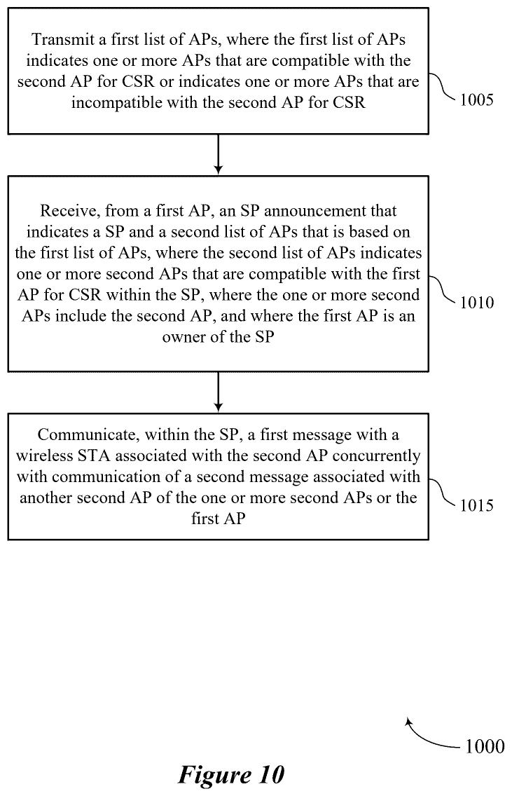

FIG. 8 shows a block diagram of an example wireless communication device 800 that supports CSR with restricted medium sharing. In some examples, the wireless communication device 800 is configured to perform the processes 900 and 1000 described with reference to FIGS. 9 and 10, respectively. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in an AP, such as the AP 102 described with reference to FIG. 1. In some other examples, the wireless communication device 800 can be an AP that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes at least one external network interface coupled with the processing system that enables communication with a core network or backhaul network that enables the wireless communication device 800 to gain access to external networks including the Internet.

The wireless communication device 800 includes a first list reception component 825, an SP announcement component 830, an CSR communication component 835, a first list transmission component 840, an SP announcement reception component 845, a signal strength monitoring component 850, a list generation component 855, and a medium sharing rules component 860. Portions of one or more of the first list reception component 825, the SP announcement component 830, the CSR communication component 835, the first list transmission component 840, the SP announcement reception component 845, the signal strength monitoring component 850, the list generation component 855, and the medium sharing rules component 860 may be implemented at least in part in hardware or firmware. For example, one or more of the first list reception component 825, the SP announcement component 830, the CSR communication component 835, the first list transmission component 840, the SP announcement reception component 845, the signal strength monitoring component 850, the list generation component 855, and the medium sharing rules component 860 may be implemented at least in part by at least a processor or a modem. In some examples, portions of one or more of the first list reception component 825, the SP announcement component 830, the CSR communication component 835, the first list transmission component 840, the SP announcement reception component 845, the signal strength monitoring component 850, the list generation component 855, and the medium sharing rules component 860 may be implemented at least in part by a processor and software in the form of processor-executable code stored in memory.

The wireless communication device 800 may support wireless communication in accordance with examples as disclosed herein. The first list reception component 825 is configurable or configured to receive a set of multiple first lists of APs from a set of multiple APs, where each first list of APs of the set of multiple first lists of APs indicates one or more APs that are compatible with a list sending AP of the plurality of APs for CSR or indicates one or more APs that are incompatible with the list sending AP for CSR. The SP announcement component 830 is configurable or configured to transmit a SP announcement that indicates a SP and a second list of APs that is based on the set of multiple first lists of APs, where the second list of APs indicates one or more second APs that are compatible with the first AP for CSR within the SP, where the first AP is an owner of the SP. The CSR communication component 835 is configurable or configured to communicate, within the SP, a first message with a wireless station (STA) associated with the first AP concurrently with communication of a second message associated with a second AP of the one or more second APs.

In some examples, the first message is communicated based on a channel occupancy time period associated with the second message being ignored.

In some examples, the second message indicates the channel occupancy time period.

In some examples, the signal strength monitoring component 850 is configurable or configured to monitor a strength of one or more signals corresponding to one or more APs. In some examples, the list generation component 855 is configurable or configured to generate, based on the strength of the one or more signals and a threshold signal strength, a third list of APs that indicates which of the one or more APs is compatible with the first AP for CSR or which of the one or more APs is incompatible with the first AP for CSR, where the second list of APs is further based on the third list of APs.

In some examples, the threshold signal strength is associated with the first AP and is the same as or different than one or more second threshold signal strengths associated with the one or more APs.

In some examples, the set of multiple first lists of APs are received within one or more beacon frames, one or more reduced neighbor report information elements, one or more information elements associated with communication of first lists of APs, one or more action frames associated with communication of first lists of APs, one or more broadcast management frames, or any combination thereof.

In some examples, the SP announcement component 830 is configurable or configured to transmit a second SP announcement that indicates a second SP and a fourth list of APs, where the fourth list of APs indicates one or more third APs that are compatible with the first AP for CSR within the second SP, and where the fourth list of APs differs from the second list of APs.

In some examples, at least one second AP indicated by the second list of APs is incompatible for CSR with at least one third AP indicated by the fourth list of APs.

In some examples, the first list reception component 825 is configurable or configured to receive an updated first list of APs from at least one AP of the set of multiple APs. In some examples, the SP announcement component 830 is configurable or configured to transmit a second SP announcement that indicates a second SP and an updated second list of APs based on the updated first list of APs.

In some examples, communication of the first message with the STA within the SP is based on the STA being classified as an inner client.

In some examples, the SP announcement further indicates a duration of the SP.

In some examples, the medium sharing rules component 860 is configurable or configured to transmit an indication of one or more medium sharing rules, where communication of the first message concurrently with the communication of the second message within the SP is based on the one or more medium sharing rules.

In some examples, the first AP is a sharing AP and the one or more second APs are one or more shared APs.

Additionally, or alternatively, the wireless communication device 800 may support wireless communication in accordance with examples as disclosed herein. The first list transmission component 840 is configurable or configured to transmit a first list of APs, where the first list of APs indicates one or more APs that are compatible with the second AP for CSR or indicates one or more APs that are incompatible with the second AP for CSR. The SP announcement reception component 845 is configurable or configured to receive, from a first AP, a SP announcement that indicates a SP and a second list of APs that is based on the first list of APs, where the second list of APs indicates one or more second APs that are compatible with the first AP for CSR within the SP, where the one or more second APs include the second AP, and where the first AP is an owner of the SP. In some examples, the CSR communication component 835 is configurable or configured to communicate, within the SP, a first message with a wireless station (STA) associated with the second AP concurrently with communication of a second message associated with another second AP of the one or more second APs or the first AP.

In some examples, the first message is communicated based on a channel occupancy time period associated with the second message being ignored.

In some examples, the second message indicates the channel occupancy time period.

In some examples, the signal strength monitoring component 850 is configurable or configured to monitor a strength of one or more signals corresponding to the first AP and a set of multiple APs including the one or more second APs, where the first list of APs is based on the strength of the one or more signals and a threshold signal strength.

In some examples, the threshold signal strength is associated with the second AP and is the same as or different than one or more second threshold signal strengths associated with the first AP, the set of multiple APs, or both.

In some examples, the first list reception component 825 is configurable or configured to receive a set of multiple first lists of APs from the set of multiple APs, where each first list of APs of the set of multiple first lists of APs indicates one or more APs that are compatible with a list sending AP of the plurality of APs for CSR or indicates one or more APs that are incompatible with the list sending AP for CSR.

In some examples, the set of multiple first lists of APs are received within one or more beacon frames, one or more reduced neighbor report information elements, one or more information elements associated with communication of first lists of APs, one or more action frames associated with communication of first lists of APs, one or more broadcast management frames, or any combination thereof.

In some examples, the first list transmission component 840 is configurable or configured to transmit an updated first list of APs to at least one AP of the set of multiple APs or the first AP. In some examples, the SP announcement reception component 845 is configurable or configured to receive a second SP announcement that indicates a second SP and an updated second list of APs based on the updated first list of APs.

In some examples, the SP announcement reception component 845 is configurable or configured to receive a second SP announcement that indicates a second SP and a third list of APs, where the third list of APs indicates one or more third APs that are compatible with the first AP for CSR within the second SP, and where the third list of APs differs from the second list of APs.

In some examples, at least one second AP indicated by the second list of APs is incompatible with at least one third AP indicated by the third list of APs for CSR.

In some examples, communication of the first message with the STA within the SP is based on the STA being classified as an inner client.

In some examples, the first AP is a sharing AP and the second AP is a shared AP.

FIG. 9 shows a flowchart illustrating an example process 900 performable by or at a first AP that supports CSR with restricted medium sharing. The operations of the process 900 may be implemented by a first AP or its components as described herein. For example, the process 900 may be performed by a wireless communication device, such as the wireless communication device 800 described with reference to FIG. 8, operating as or within a wireless AP. In some examples, the process 900 may be performed by a wireless AP, such as one of the APs 102 described with reference to FIG. 1.

In some examples, in 905, the first AP may receive a set of multiple first lists of APs from a set of multiple APs, where each first list of APs of the set of multiple first lists of APs indicates one or more APs that are compatible with a list sending AP of the plurality of APs for CSR or indicates one or more APs that are incompatible with the list sending AP for CSR. The operations of 905 may be performed in accordance with examples as disclosed herein. In some implementations, aspects of the operations of 905 may be performed by a first list reception component 825 as described with reference to FIG. 8.

In some examples, in 910, the first AP may transmit a SP announcement that indicates a SP and a second list of APs that is based on the set of multiple first lists of APs, where the second list of APs indicates one or more second APs that are compatible with the first AP for CSR within the SP, where the first AP is an owner of the SP. The operations of 910 may be performed in accordance with examples as disclosed herein. In some implementations, aspects of the operations of 910 may be performed by an SP announcement component 830 as described with reference to FIG. 8.

In some examples, in 915, the first AP may communicate, within the SP, a first message with a wireless STA associated with the first AP concurrently with communication of a second message associated with a second AP of the one or more second APs. The operations of 915 may be performed in accordance with examples as disclosed herein. In some implementations, aspects of the operations of 915 may be performed by an CSR communication component 835 as described with reference to FIG. 8.

FIG. 10 shows a flowchart illustrating an example process 1000 performable by or at a second AP that supports CSR with restricted medium sharing. The operations of the process 1000 may be implemented by a second AP or its components as described herein. For example, the process 1000 may be performed by a wireless communication device, such as the wireless communication device 800 described with reference to FIG. 8, operating as or within a wireless AP. In some examples, the process 1000 may be performed by a wireless AP, such as one of the APs 102 described with reference to FIG. 1.

In some examples, in 1005, the second AP may transmit a first list of APs, where the first list of APs indicates one or more APs that are compatible with the second AP for CSR or indicates one or more APs that are incompatible with the second AP for CSR. The operations of 1005 may be performed in accordance with examples as disclosed herein. In some implementations, aspects of the operations of 1005 may be performed by a first list transmission component 840 as described with reference to FIG. 8.

In some examples, in 1010, the second AP may receive, from a first AP, a SP announcement that indicates a SP and a second list of APs that is based on the first list of APs, where the second list of APs indicates one or more second APs that are compatible with the first AP for CSR within the SP, where the one or more second APs include the second AP, and where the first AP is an owner of the SP. The operations of 1010 may be performed in accordance with examples as disclosed herein. In some implementations, aspects of the operations of 1010 may be performed by an SP announcement reception component 845 as described with reference to FIG. 8.

In some examples, in 1015, the second AP may communicate, within the SP, a first message with a wireless STA associated with the second AP concurrently with communication of a second message associated with another second AP of the one or more second APs or the first AP. The operations of 1015 may be performed in accordance with examples as disclosed herein. In some implementations, aspects of the operations of 1015 may be performed by an CSR communication component 835 as described with reference to FIG. 8.

Implementation examples are described in the following numbered clauses:
Aspect 1: A method for wireless communication at a first AP, comprising: receiving a plurality of first lists of APs from a plurality of APs, wherein each first list of APs of the plurality of first lists of APs indicates one or more APs that are compatible with a list sending AP of the plurality of APs for CSR, or indicates one or more APs that are incompatible with the list sending AP for CSR; transmitting a SP announcement that indicates a SP and a second list of APs that is based at least in part on the plurality of first lists of APs, wherein the second list of APs indicates one or more second APs that are compatible with the first AP for CSR within the SP, wherein the first AP is an owner of the SP; and communicating, within the SP, a first message with a wireless STA associated with the first AP concurrently with communication of a second message associated with a second AP of the one or more second APs.
Aspect 2: The method of aspect 1, wherein the first message is communicated based at least in part on a channel occupancy time period associated with the second message being ignored.
Aspect 3: The method of aspect 2, wherein the second message indicates the channel occupancy time period.
Aspect 4: The method of any of aspects 1-3, further comprising: monitoring a strength of one or more signals corresponding to one or more APs; and generating, based at least in part on the strength of the one or more signals and a threshold signal strength, a third list of APs that indicates which of the one or more APs is compatible with the first AP for CSR or which of the one or more APs is incompatible with the first AP for CSR, wherein the second list of APs is further based at least in part on the third list of APs.
Aspect 5: The method of aspect 4, wherein the threshold signal strength is associated with the first AP and is the same as or different than one or more second threshold signal strengths associated with the one or more APs.
Aspect 6: The method of any of aspects 1-5, wherein the plurality of first lists of APs are received within one or more beacon frames, one or more RNR information elements, one or more information elements associated with communication of first lists of APs, one or more action frames associated with communication of first lists of APs, one or more broadcast management frames, or any combination thereof.
Aspect 7: The method of any of aspects 1-6, further comprising: transmitting a second SP announcement that indicates a second SP and a fourth list of APs, wherein the fourth list of APs indicates one or more third APs that are compatible with the first AP for CSR within the second SP, and wherein the fourth list of APs differs from the second list of APs.
Aspect 8: The method of aspect 7, wherein at least one second AP indicated by the second list of APs is incompatible for CSR with at least one third AP indicated by the fourth list of APs.
Aspect 9: The method of any of aspects 1-8, further comprising: receiving an updated first list of APs from at least one AP of the plurality of APs; and transmitting a second SP announcement that indicates a second SP and an updated second list of APs based at least in part on the updated first list of APs.
Aspect 10: The method of any of aspects 1-9, wherein communication of the first message with the STA within the SP is based at least in part on the STA being classified as an inner client.
Aspect 11: The method of any of aspects 1-10, wherein the SP announcement further indicates a duration of the SP.
Aspect 12: The method of any of aspects 1-11, further comprising: transmitting an indication of one or more medium sharing rules, wherein communication of the first message concurrently with the communication of the second message within the SP is based at least in part on the one or more medium sharing rules.
Aspect 13: The method of any of aspects 1-12, wherein the first AP is a sharing AP and the one or more second APs are one or more shared APs.
Aspect 14: A method for wireless communication at a second AP, comprising: transmitting a first list of APs, wherein the first list of APs indicates one or more APs that are compatible with the second AP for CSR or indicates one or more APs that are incompatible with the second AP for CSR; receiving, from a first AP, a SP announcement that indicates a SP and a second list of APs that is based at least in part on the first list of APs, wherein the second list of APs indicates one or more second APs that are compatible with the first AP for CSR within the SP, wherein the one or more second APs comprise the second AP, and wherein the first AP is an owner of the SP; and communicating, within the SP, a first message with a wireless STA associated with the second AP concurrently with communication of a second message associated with another second AP of the one or more second APs or the first AP.
Aspect 15: The method of aspect 14, wherein the first message is communicated based at least in part on a channel occupancy time period associated with the second message being ignored.
Aspect 16: The method of aspect 15, wherein the second message indicates the channel occupancy time period.
Aspect 17: The method of any of aspects 14-16, further comprising: monitoring a strength of one or more signals corresponding to the first AP and a plurality of APs comprising the one or more second APs, wherein the first list of APs is based at least in part on the strength of the one or more signals and a threshold signal strength.
Aspect 18: The method of aspect 17, wherein the threshold signal strength is associated with the second AP and is the same as or different than one or more second threshold signal strengths associated with the first AP, the plurality of APs, or both.
Aspect 19: The method of any of aspects 17-18, further comprising: receiving a plurality of first lists of APs from the plurality of APs, wherein each first list of APs of the plurality of first lists of APs indicates one or more APs that are compatible with a list sending AP of the plurality of APs for CSR, or indicates one or more APs that are incompatible with the list sending AP for CSR.
Aspect 20: The method of aspect 19, wherein the plurality of first lists of APs are received within one or more beacon frames, one or more RNR information elements, one or more information elements associated with communication of first lists of APs, one or more action frames associated with communication of first lists of APs, one or more broadcast management frames, or any combination thereof.
Aspect 21: The method of any of aspects 19-20, further comprising: transmitting an updated first list of APs to at least one AP of the plurality of APs or the first AP; and receiving a second SP announcement that indicates a second SP and an updated second list of APs based at least in part on the updated first list of APs.
Aspect 22: The method of any of aspects 14-21, further comprising: receiving a second SP announcement that indicates a second SP and a third list of APs, wherein the third list of APs indicates one or more third APs that are compatible with the first AP for CSR within the second SP, and wherein the third list of APs differs from the second list of APs.
Aspect 23: The method of aspect 22, wherein at least one second AP indicated by the second list of APs is incompatible with at least one third AP indicated by the third list of APs for CSR.
Aspect 24: The method of any of aspects 14-23, wherein communication of the first message with the STA within the SP is based at least in part on the STA being classified as an inner client.
Aspect 25: The method of any of aspects 14-24, wherein the first AP is a sharing AP and the second AP is a shared AP.
Aspect 26: A first AP for wireless communication, comprising one or more memories storing processor-executable code, and one or more processors coupled with the one or more memories and individually or collectively operable to execute the code to cause the first AP to perform a method of any of aspects 1-13.
Aspect 27: A first AP for wireless communication, comprising at least one means for performing a method of any of aspects 1-13.
Aspect 28: A non-transitory computer-readable medium storing code for wireless communication, the code comprising instructions executable by one or more processors to perform a method of any of aspects 1-13.
Aspect 29: A second AP for wireless communication, comprising one or more memories storing processor-executable code, and one or more processors coupled with the one or more memories and individually or collectively operable to execute the code to cause the second AP to perform a method of any of aspects 14-25.
Aspect 30: A second AP for wireless communication, comprising at least one means for performing a method of any of aspects 14-25.
Aspect 31: A non-transitory computer-readable medium storing code for wireless communication, the code comprising instructions executable by one or more processors to perform a method of any of aspects 14-25.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset”refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous.

Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
one or more memories storing processor-executable code; and
one or more processors coupled with the one or more memories and individually or collectively operable to execute the code to cause the first AP to:
receive a plurality of first lists of APs from a plurality of APs, wherein each first list of APs of the plurality of first lists of APs indicates one or more APs that are compatible with a list sending AP of the plurality of APs for coordinated spatial reuse or indicates one or more APs that are incompatible with the list sending AP for coordinated spatial reuse;
transmit a service period announcement that indicates a service period and a second list of APs that is based at least in part on the plurality of first lists of APs, wherein the second list of APs indicates one or more second APs that are compatible with the first AP for coordinated spatial reuse within the service period, wherein the first AP is an owner of the service period; and
communicate, within the service period, a first message with a wireless station (STA) associated with the first AP concurrently with communication of a second message associated with a second AP of the one or more second APs.

2. The first AP of claim 1, wherein the first message is communicated based at least in part on a channel occupancy time period associated with the second message being ignored.

3. The first AP of claim 2, wherein the second message indicates the channel occupancy time period.

4. The first AP of claim 1, wherein the one or more processors are individually or collectively further operable to execute the code to cause the first AP to:
monitor a strength of one or more signals corresponding to one or more APs; and
generate, based at least in part on the strength of the one or more signals and a threshold signal strength, a third list of APs that indicates which of the one or more APs is compatible with the first AP for coordinated spatial reuse or which of the one or more APs is incompatible with the first AP for coordinated spatial reuse, wherein the second list of APs is further based at least in part on the third list of APs.

5. The first AP of claim 4, wherein the threshold signal strength is associated with the first AP and is the same as or different than one or more second threshold signal strengths associated with the one or more APs.

6. The first AP of claim 1, wherein the plurality of first lists of APs are received within one or more beacon frames, one or more reduced neighbor report information elements, one or more information elements associated with communication of first lists of APs, one or more action frames associated with communication of first lists of APs, one or more broadcast management frames, or any combination thereof.

7. The first AP of claim 1, wherein the one or more processors are individually or collectively further operable to execute the code to cause the first AP to:
transmit a second service period announcement that indicates a second service period and a fourth list of APs, wherein the fourth list of APs indicates one or more third APs that are compatible with the first AP for coordinated spatial reuse within the second service period, and wherein the fourth list of APs differs from the second list of APs.

8. The first AP of claim 7, wherein at least one second AP indicated by the second list of APs is incompatible for coordinated spatial reuse with at least one third AP indicated by the fourth list of APs.

9. The first AP of claim 1, wherein the one or more processors are individually or collectively further operable to execute the code to cause the first AP to:
receive an updated first list of APs from at least one AP of the plurality of APs; and
transmit a second service period announcement that indicates a second service period and an updated second list of APs based at least in part on the updated first list of APs.

10. The first AP of claim 1, wherein communication of the first message with the STA within the service period is based at least in part on the STA being classified as an inner client.

11. The first AP of claim 1, wherein the service period announcement further indicates a duration of the service period.

12. The first AP of claim 1, wherein the one or more processors are individually or collectively further operable to execute the code to cause the first AP to:
transmit an indication of one or more medium sharing rules, wherein communication of the first message concurrently with the communication of the second message within the service period is based at least in part on the one or more medium sharing rules.

13. The first AP of claim 1, wherein the first AP is a sharing AP and the one or more second APs are one or more shared APs.

14. A method for wireless communication at a first access point (AP), comprising:
receiving a plurality of first lists of APs from a plurality of APs, wherein each first list of APs of the plurality of first lists of APs indicates one or more APs that are compatible with a list sending AP of the plurality of APs for coordinated spatial reuse or indicates one or more APs that are incompatible with the list sending AP for coordinated spatial reuse;
transmitting a service period announcement that indicates a service period and a second list of APs that is based at least in part on the plurality of first lists of APs, wherein the second list of APs indicates one or more second APs that are compatible with the first AP for coordinated spatial reuse within the service period, wherein the first AP is an owner of the service period; and
communicating, within the service period, a first message with a wireless station (STA) associated with the first AP concurrently with communication of a second message associated with a second AP of the one or more second APs.

15. The method of claim 14, wherein the first message is communicated based at least in part on a channel occupancy time period associated with the second message being ignored.

16. The method of claim 15, wherein the second message indicates the channel occupancy time period.

17. A second access point (AP), comprising:
one or more memories storing processor-executable code; and
one or more processors coupled with the one or more memories and individually or collectively operable to execute the code to cause the second AP to:
transmit a first list of APs, wherein the first list of APs indicates one or more APs that are compatible with the second AP for coordinated spatial reuse or indicates one or more APs that are incompatible with the second AP for coordinated spatial reuse;
receive, from a first AP, a service period announcement that indicates a service period and a second list of APs that is based at least in part on the first list of APs, wherein the second list of APs indicates one or more second APs that are compatible with the first AP for coordinated spatial reuse within the service period, wherein the one or more second APs comprise the second AP, and wherein the first AP is an owner of the service period; and
communicate, within the service period, a first message with a wireless station (STA) associated with the second AP concurrently with communication of a second message associated with another second AP of the one or more second APs or the first AP.

18. The second AP of claim 17, wherein the first message is communicated based at least in part on a channel occupancy time period associated with the second message being ignored.

19. The second AP of claim 18, wherein the second message indicates the channel occupancy time period.

20. The second AP of claim 17, wherein the one or more processors are individually or collectively further operable to execute the code to cause the second AP to:
monitor a strength of one or more signals corresponding to the first AP and a plurality of APs comprising the one or more second APs, wherein the first list of APs is based at least in part on the strength of the one or more signals and a threshold signal strength.

21. The second AP of claim 20, wherein the threshold signal strength is associated with the second AP and is the same as or different than one or more second threshold signal strengths associated with the first AP, the plurality of APs, or both.

22. The second AP of claim 20, wherein the one or more processors are individually or collectively further operable to execute the code to cause the second AP to:
receive a plurality of first lists of APs from the plurality of APs, wherein each first list of APs of the plurality of first lists of APs indicates one or more APs that are compatible with a list sending AP of the plurality of APs for coordinated spatial reuse or indicates one or more APs that are incompatible with the list sending AP for coordinated spatial reuse.

23. The second AP of claim 22, wherein the plurality of first lists of APs are received within one or more beacon frames, one or more reduced neighbor report information elements, one or more information elements associated with communication of first lists of APs, one or more action frames associated with communication of first lists of APs, one or more broadcast management frames, or any combination thereof.

24. The second AP of claim 22, wherein the one or more processors are individually or collectively further operable to execute the code to cause the second AP to:
transmit an updated first list of APs to at least one AP of the plurality of APs or the first AP; and
receive a second service period announcement that indicates a second service period and an updated second list of APs based at least in part on the updated first list of APs.

25. The second AP of claim 17, wherein the one or more processors are individually or collectively further operable to execute the code to cause the second AP to:
receive a second service period announcement that indicates a second service period and a third list of APs, wherein the third list of APs indicates one or more third APs that are compatible with the first AP for coordinated spatial reuse within the second service period, and wherein the third list of APs differs from the second list of APs.

26. The second AP of claim 25, wherein at least one second AP indicated by the second list of APs is incompatible with at least one third AP indicated by the third list of APs for coordinated spatial reuse.

27. The second AP of claim 17, wherein communication of the first message with the STA within the service period is based at least in part on the STA being classified as an inner client.

28. The second AP of claim 17, wherein the first AP is a sharing AP and the second AP is a shared AP.

29. A method for wireless communication at a second access point (AP), comprising:
transmitting a first list of APs, wherein the first list of APs indicates one or more APs that are compatible with the second AP for coordinated spatial reuse or indicates one or more APs that are incompatible with the second AP for coordinated spatial reuse;
receiving, from a first AP, a service period announcement that indicates a service period and a second list of APs that is based at least in part on the first list of APs, wherein the second list of APs indicates one or more second APs that are compatible with the first AP for coordinated spatial reuse within the service period, wherein the one or more second APs comprise the second AP, and wherein the first AP is an owner of the service period; and
communicating, within the service period, a first message with a wireless station (STA) associated with the second AP concurrently with communication of a second message associated with another second AP of the one or more second APs or the first AP.

30. The method of claim 29, wherein the first message is communicated based at least in part on a channel occupancy time period associated with the second message being ignored.
